(19) United States
(12) Patent Application Publication
(10) Pub. No.: US 2025/0309394 A1
(43) Pub. Date: Oct. 2, 2025

(54) ALL-SOLID-STATE BATTERY

(71) Applicant: HONDA MOTOR CO., LTD., Tokyo (JP)

(72) Inventors: Kizashi IWAKIRI, Saitama (JP); Takuya TANIUCHI, Saitama (JP); Masahiro HOKAZONO, Saitama (JP); Fumikazu NAKAZAWA, Saitama (JP)

(21) Appl. No.: 19/051,200

(22) Filed: Feb. 12, 2025

(30) Foreign Application Priority Data
Mar. 26, 2024 (JP) 2024-048936

(51) Int. Cl. H01M 10/613; H01M 10/0585; H01M 10/6551; H01M 50/46; H01M 50/477

(52) U.S. Cl. CPC H01M 10/613; H01M 10/0585; H01M 10/6551; H01M 50/46; H01M 50/477

(57) ABSTRACT

The present disclosure addresses the problem of providing an all-solid-state battery capable of suppressing damage to the ends of the positive electrode layer under compressive stress due to compressive input, while ensuring sufficient insulation between the positive electrode and the negative electrode. An all-solid-state battery according to one embodiment of the present disclosure includes an electrode stack 1 including a plurality of electrode bodies stacked. Positive electrode insulating layers 8a, 8b at the ends of the positive electrode current collector 4, protruding in the direction Vd (plane direction) perpendicular to the stacking direction. An insulating layer 20 and a heat transfer layer 30 are provided in this order at the ends of the electrode stack 1 in the direction Vd perpendicular to the stacking direction Ld. The interface 40 between the insulating layer 20 and the heat transfer layer 30 includes a concavo-convex shape portion.

This application is based on and claims the benefit of priority from Japanese Patent Application No. 2024-048936, filed on 26 Mar. 2024, the content of which is incorporated herein by reference.

### BACKGROUND OF THE INVENTION

### Field of the Invention

The present invention relates to an all-solid-state battery.

### Related Art

In recent years, research and development on secondary batteries contributing to energy efficiency have been conducted to ensure more people have access to affordable, reliable, sustainable, and advanced energy solutions. Among secondary batteries, lithium metal batteries with high energy density have attracted significant attention.

Lithium metal batteries are secondary batteries that use lithium metal as the negative electrode, potentially enabling high-capacity batteries. In particular, so-called all-solid-state lithium metal batteries, which replace the liquid electrolyte with a solid electrolyte layer, have drawn attention due to their superior safety. The cell structure of all-solid-state lithium metal batteries include, for example, a negative electrode made of lithium metal, a positive electrode, and a solid electrolyte layer.

FIG. 3 is a cross-sectional view illustrating a portion of an all-solid-state battery according to one embodiment. As illustrated in FIG. 3, the electrode stack 1 of the all-solid-state battery includes: a negative electrode formed of a negative electrode current collector 2a and a lithium metal layer (negative electrode layer) 3a, or formed of a negative electrode current collector 2b and a lithium metal layer (negative electrode layer) 3b; a positive electrode formed of a positive electrode current collector 4 and a positive electrode active material layer (positive electrode layer) 5a or 5b; and solid electrolyte layers 6a and 6b adjacent to the positive electrode active material layers (positive electrode layers) 5a and 5b, respectively.

The electrode stack 1 of the all-solid-state battery illustrated in FIG. 3 includes: an intermediate layer 7a between the lithium metal layer (negative electrode layer) 3a and the solid electrolyte layer 6a; and an intermediate layer 7b between the lithium metal layer (negative electrode layer) 3b and the solid electrolyte layer 6b.

Insulating materials 8a are arranged at both ends of the positive electrode active material layer (positive electrode layer) 5a, and insulating materials 8b are arranged at both ends of the positive electrode active material layer (positive electrode layer) 5b. In the drawings, Ld denotes the stacking direction of the electrode stack 1 constituting the all-solid-state battery, and Vd denotes a direction (plane direction) perpendicular to the stacking direction of the electrode stack 1 constituting the all-solid-state battery.

The module assembly process of an all-solid-state battery includes a step of applying compressive input, in which a compressive stress of approximately 1 MPa is applied. As indicated by the thick white arrow, the compressive input applies pressure to the electrode stack 1 from the outside in the direction Vd perpendicular to the stacking direction Ld of the electrode stack 1.

As illustrated in FIG. 3, the electrode stack 1 has a structure, in which the positive electrode active material layers (positive electrode layers) 5a and 5b including the insulating material 8a and 8b at the ends, respectively, extend outward beyond the ends of the electrode stack 1 in the direction (plane direction) Vd perpendicular to the stacking direction Ld of the electrode stack 1. As a result, when compressive stress is applied, damage such as bending or breaking may occur in the positive electrode active material layers (positive electrode layers) 5a or 5b along with the insulating materials 8a or 8b at the ends.

Accordingly, in order to suppress damage to the ends of the positive electrode under compressive stress due to compressive input, while ensuring sufficient insulation between the positive electrode and the negative electrode, it has been proposed to provide a protective layer made of a resin coating on the side surfaces of the extending portions of the electrode stack.
Patent Document 1: Japanese Unexamined Patent Application, Publication No. 2023-39756

### SUMMARY OF THE INVENTION

However, when resin is applied to the ends of the electrode stack to ensure insulation between the positive electrode side and the negative electrode side, thermal conductivity is typically lowered. As illustrated in FIG. 4 (conventional example illustrating the operation of one embodiment), the insulating material 50 applied to the ends of the electrode stack takes a semi-circular cross-sectional shape similar to part of a spherical surface, due to the viscosity of the material, resulting in only the central area in contact with the housing 60. As a result, the heat transfer area between the insulating material 50 and the housing 60 is reduced, decreasing the amount of heat dissipation.

On the other hand, in general, most of the heat transfer materials are electrically conductive; therefore, directly applying the heat transfer materials to the ends of the electrode stack, which require the insulating function, is challenging. Even in a case where the heat transfer material is an insulator, typical insulating heat-dissipation pastes or greases are soft. Therefore, the effect in dispersing compressive stress on the ends of the electrode stack is small.

The present invention has been made in view of the above, and an object of the present invention is to provide an all-solid-state battery capable of suppressing damage to the ends of the positive electrode layer under compressive stress due to compressive input, while ensuring sufficient insulation between the positive electrode and the negative electrode.

The all-solid-state battery of the present disclosure includes the following aspects:
(1) An all-solid-state battery, including: an electrode stack including a plurality of electrode bodies stacked, each of the electrode bodies including a positive electrode current collector, a positive electrode layer, a solid electrolyte layer, a negative electrode layer, and a negative electrode current collector stacked in this order, and a positive electrode insulating layer at an end of the positive electrode current collector, protruding in a direction (plane direction) perpendicular to the stacking direction, in which an insulating layer and a heat transfer layer are provided in this order at an end of the electrode stack in a direction perpendicular to a stacking direction, and an interface between the insulating layer and the heat transfer layer includes a concavo-convex shape portion.
(2) The all-solid-state battery as described in (1), in which the minimum value of the thickness of the insulating layer is 0.05 mm.
(3) The all-solid-state battery as described in (1) or (2), in which the maximum value of the thickness of the insulating layer is at least 1.1 times the minimum value of the thickness, and is no greater than the maximum value of the thickness of the heat transfer layer, and the maximum value of the thickness of the heat transfer layer is no greater than 20 mm.
(4) The all-solid-state battery as described in (1) or (2), in which the concavo-convex shape portion includes a plurality of concavo-convex shape parts.
(5) The all-solid-state battery as described in (4), in which the plurality of concavo-convex shape parts form a concavo-convex pattern that follows a specific regular arrangement.
(6) The all-solid-state battery as described in (5), in which the gap between adjacent convex portions on the insulating layer side of the plurality of concavo-convex shape parts is at least 0.05 mm.
(7) The all-solid-state battery as described in (4), in which the plurality of concavo-convex shape parts form a random concavo-convex pattern.

In the all-solid-state battery of the aspect (1), the insulating layer is capable of suppressing damage to the ends of the positive electrode layer under compressive stress due to compressive input, while ensuring sufficient insulation between the positive electrode and the negative electrode. The interface between the insulating layer and the heat transfer layer includes the concavo-convex shape portion, whereby the contact area (heat transfer area) between the insulating layer and the heat transfer layer is increased, enabling effective heat dissipation from the insulating layer to the heat transfer layer, and subsequently to the housing of the all-solid-state battery.

In the all-solid-state battery of the aspect (2), the minimum value of the thickness of the insulating layer is 0.05 mm, thereby allowing for ensuring sufficient insulation between the positive electrode and the negative electrode without obstructing heat transfer from the electrode stack to the heat transfer layer via the insulating layer.

In the all-solid-state battery of the aspect (3), the maximum value of the thickness of the insulating layer is at least 1.1 times the minimum value of the thickness, and is no greater than the maximum value of the thickness of the heat transfer layer, in which the maximum value of the thickness of the heat transfer layer is at least 20 mm. This value of the thickness of the heat transfer layer is the practical maximum value, from the perspective of energy density.

In the all-solid-state battery of the aspect (4), the concavo-convex shape portion at the interface between the insulating layer and the heat transfer layer includes a plurality of concavo-convex shape parts. As a result, the contact area (heat transfer area) between the insulating layer and the heat transfer layer is increased, enabling effective heat dissipation from the insulating layer to the heat transfer layer, and subsequently to the housing of the all-solid-state battery.

In the all-solid-state battery of the aspect (5), the plurality of concavo-convex shape parts at the interface between the insulating layer and the heat transfer layer form a concavo-convex pattern that follows a specific regular arrangement. Therefore, thermal resistance across the interface is equalized in the in-plane position perpendicular to the stacking direction of the electrode stack, enabling effective heat dissipation regardless of the in-plane position.

In the all-solid-state battery of the aspect (6), the gap between adjacent convex portions on the insulating layer side of the plurality of concavo-convex shape parts at the interface between the insulating layer and the heat transfer layer is at least 0.05 mm. According to simulations, when the gap is selected between adjacent convex portions on the insulating layer side of the plurality of concavo-convex shape parts, heat is effectively dissipated from the electrode stack.

In the all-solid-state battery of the aspect (7), the plurality of concavo-convex shape parts at the interface between the insulating layer and the heat transfer layer form a random concavo-convex pattern. According to simulations, even in cases where the plurality of concavo-convex shape parts at the interface between the insulating layer and the heat transfer layer are formed into a random concavo-convex pattern, heat is also effectively dissipated from the electrode stack.

### BRIEF DESCRIPTION OF THE DRAWINGS

FIG. 1 is a cross-sectional view illustrating the configuration of an all-solid-state battery of the first embodiment;

FIG. 2 is a cross-sectional view illustrating the configuration of an all-solid-state battery of the second embodiment;

FIG. 3 is a cross-sectional view illustrating a portion of an all-solid-state battery of one embodiment; and

FIG. 4 is a cross-sectional view illustrating the configuration of an all-solid-state battery of the conventional art;

### DETAILED DESCRIPTION OF THE INVENTION

### (All-Solid-State Battery)

The all-solid-state battery of the present disclosure includes an electrode stack including a plurality of electrode bodies including a positive electrode current collector, a positive electrode layer, a solid electrolyte layer, a negative electrode layer, and a negative electrode current collector stacked in this order. The positive electrode current collector includes an insulating material on the surface on the positive electrode layer side, adjacent to the end of the positive electrode layer. The solid electrolyte layer is arranged in contact with the positive electrode layer and the insulating material.

In the all-solid-state battery of the present disclosure, the end of the insulating material is arranged outward beyond the end of the negative electrode layer and the end of the negative electrode current collector, in the direction perpendicular to the stacking direction of the electrode stack; and an insulating layer and a heat transfer layer are provided in this order at the end of the electrode stack, in contact with the end of the insulating material, in the direction perpendicular to the stacking direction of the electrode stack.

In the all-solid-state battery of the present disclosure, the insulating layer and the heat transfer layer are arranged at both ends of the electrode stack in the stacking direction.

The insulating layer and the heat transfer layer are provide at both ends of the electrode stack in the stacking direction, whereby the insulating layer functions to maintain sufficient insulation between the positive electrode and the negative electrode, while the heat transfer layer functions to mitigate compressive stress due to compressive input and to dissipate heat. Consequently, the all-solid-state battery of the present invention can suppress damage to the ends of the positive electrode layer.

Next, the configuration and operation of the all-solid-state battery of the present disclosure will be described with reference to the drawings. In each of the drawings referenced in this description, the corresponding components are denoted by the same reference numerals.

### First Embodiment

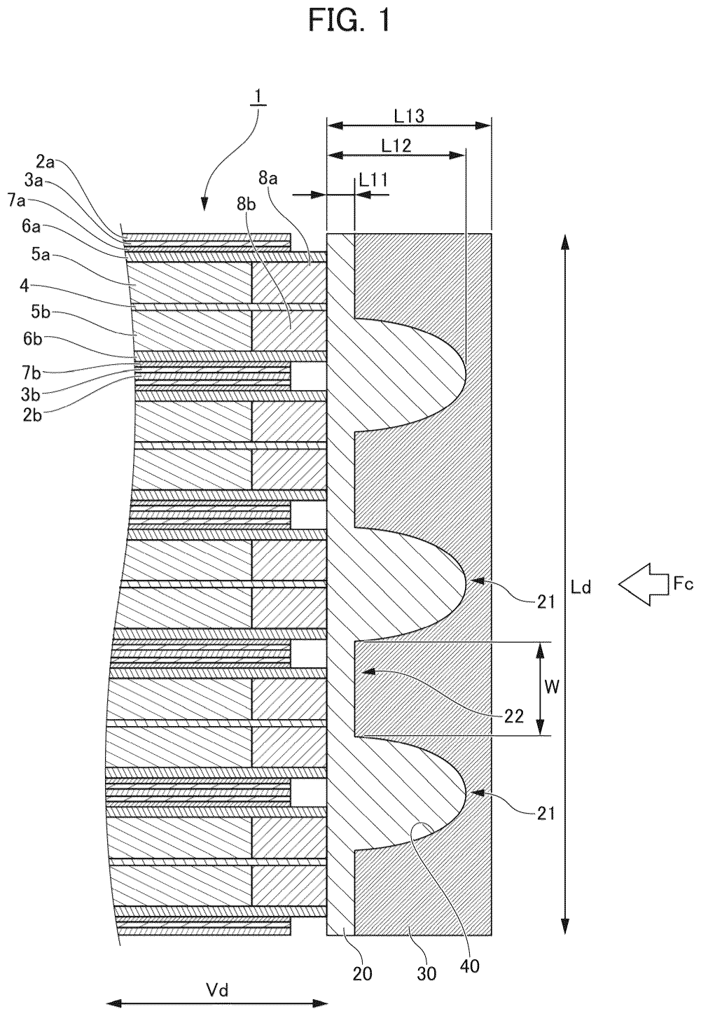

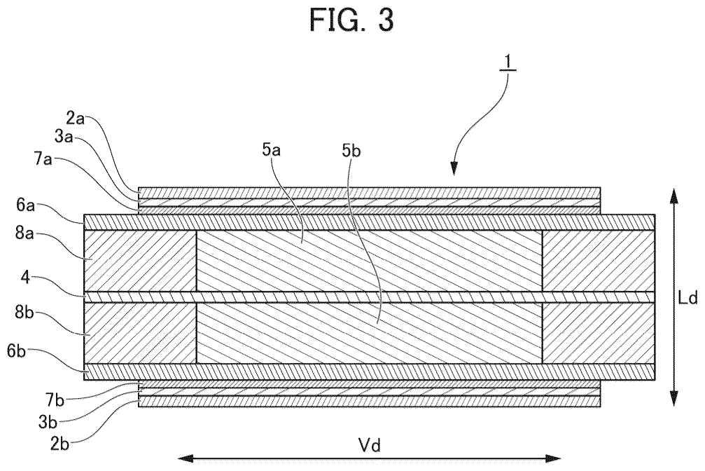

FIG. 1 is a cross-sectional view illustrating the configuration of an all-solid-state battery according to the first embodiment. The electrode stack 1 of the all-solid-state battery illustrated in FIG. 1 includes: a negative electrode formed of a negative electrode current collector 2a and a lithium metal layer (negative electrode layer) 3a, or a negative electrode current collector 2b and a lithium metal layer (negative electrode layer) 3b; a positive electrode including a positive electrode current collector 4 and a positive electrode active material layer (positive electrode layer) 5a or 5b; and solid electrolyte layers 6a and 6b adjacent to the positive electrode active material layers (positive electrode layers) 5a or 5b. FIG. 1 illustrates one end side (the right end side in the cross-sectional view) of the electrode stack 1 of the all-solid-state battery. The configuration of the other end side of the electrode stack 1 (the left end side in the cross-sectional view) is plane-symmetrical with respect to the configuration on this one end side (see FIG. 3 as appropriate).

The electrode stack 1 of the all-solid-state battery illustrated in FIG. 1 further includes: an intermediate layer 7a arranged between the lithium metal layer (negative electrode layer) 3a and the solid electrolyte layer 6a; and an intermediate layer 7b arranged between the lithium metal layers (negative electrode layer) 3b and the solid electrolyte layer 6b. An insulating material 8a is arranged at both ends of the positive electrode active material layer (positive electrode layer) 5a, and an insulating material 8b serving as a positive electrode insulating layer is arranged at both ends of the positive electrode active material layer (positive electrode layer) 5b. In the drawings, Vd denotes a direction (plane direction) perpendicular to the stacking direction Ld of the electrode stack 1 constituting the all-solid-state battery. During the module assembly process of the all-solid-state battery, the compressive input Fc acts in the Vd direction, as indicated by the thick white arrow.

In the all-solid-state battery of the first embodiment, the ends of the insulating materials 8a and 8b, which serve as positive electrode insulating layers in the electrode stack 1, extend outward beyond the ends of the lithium metal layers (negative electrode layers) 3a and 3b and the ends of the negative electrode current collectors 2a and 2b, in the Vd direction.

In the all-solid-state battery of the first embodiment, an insulating layer 20 composed of insulating material and a heat transfer layer 30 composed of heat-conducting material are provided in this order, as viewed in the Vd direction, at the ends of the positive electrode current collector 4, where the insulating materials 8a and 8b are provided. The insulating layer 20 and the heat transfer layer 30 are in contact at an interface 40. Publicly known insulating pastes can be applied as the insulating layer 20. Insulating materials such as paste-like silicon mixed with metal powder can be applied as the heat transfer layer 30.

As illustrated in FIG. 1, the insulating layer 20 and the heat transfer layer 30, which are in contact at the interface 40, extend in the Ld direction with a length equal to the thickness of the electrode stack 1 at the ends of the electrode stack 1 in the Vd direction. The interface 40 includes a concavo-convex shape portion. The concavo-convex shape portion includes at least two convex portions 21 protruding in the Vd direction, and concave portions 22 that are adjacent to the convex portions 21 and relatively recessed.

In the all-solid-state battery of the first embodiment illustrated in FIG. 1, the minimum value L11 of the thickness of the insulating layer 20 is 0.05 mm. As a result, sufficient insulation is ensured between the positive electrode and the negative electrode without obstructing heat transfer from the electrode stack 1 to the heat transfer layer 30 via the insulating layer 20. The minimum value L11 of the thickness of the insulating layer 20 is more preferably at least 0.1 mm.

The maximum value L12 of the thickness of the insulating layer 20 is at least 1.1 times the minimum value L13, and is no greater than the maximum value L13 of the thickness of the heat transfer layer, in which the maximum value L13 of the thickness of the heat transfer layer is no greater than 20 mm. As a result, heat is effectively dissipated without obstructing heat transfer from the electrode stack 1 to the heat transfer layer 30 via the insulating layer 20. In this case, the maximum value L13 of the thickness of the heat transfer layer is more preferably no greater than 2 mm, from the perspective of energy density. In FIG. 1, for convenience and to avoid line overlap, L11 is depicted within the range of L13; however, the thickness of the heat transfer layer 30 is separate from the thickness of the insulating layer 20.

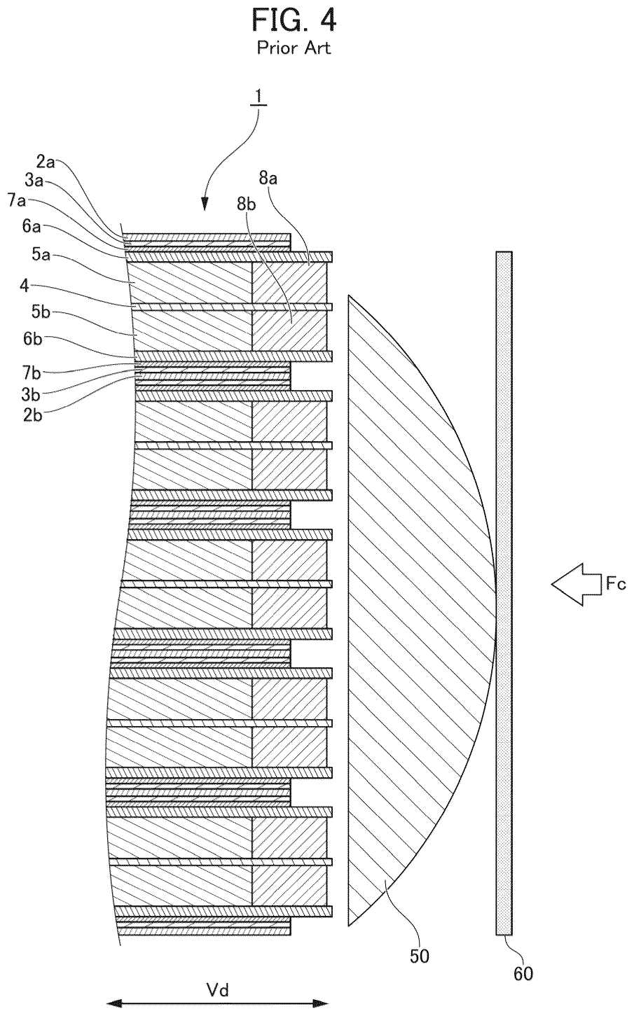

The concavo-convex shape portion at the interface 40 may include a plurality of concavo-convex shape parts. In the example illustrated in FIG. 1, in the insulating layer 20, the concavo-convex shape portions at the interface 40 are formed with the plurality of concavo-convex shape parts including the three convex portions 21 and the four adjacent concave portions 22. As a result, the contact area (heat transfer area) between the insulating layer 20 and the heat transfer layer 30 is increased, enabling effective heat dissipation from the insulating layer 20 to the heat transfer layer 30, and subsequently to the housing (the number 60 in FIG. 4) of the all-solid-state battery.

In the all-solid-state battery illustrated in FIG. 1, the plurality of concavo-convex shape parts form a concavo-convex pattern that follows a specific regular arrangement. Specifically, each convex portion 21 in the insulating layer 20 is of the same shape and size, and the width W of the concave portion 21 in the Ld direction between two adjacent convex portions 21 is constant. FIG. 1 illustrates a cross-sectional view of the convex portions 21 and concave portions 22, which extend in a direction perpendicular to the plane of the paper. The plurality of concavo-convex shape parts form a concavo-convex pattern that follows a specific regular arrangement, thereby ensuring that thermal resistance across the interface 40 is equalized in the in-plane position perpendicular to the stacking direction Ld of the electrode stack 1, enabling effective heat dissipation regardless of the in-plane position.

The width W of the concave portions 21 in the Ld direction corresponds to the gap between two adjacent convex portions 21, and the gap W is at least 0.05 mm. The gap W is more preferably at least 0.1 mm.

### Second Embodiment

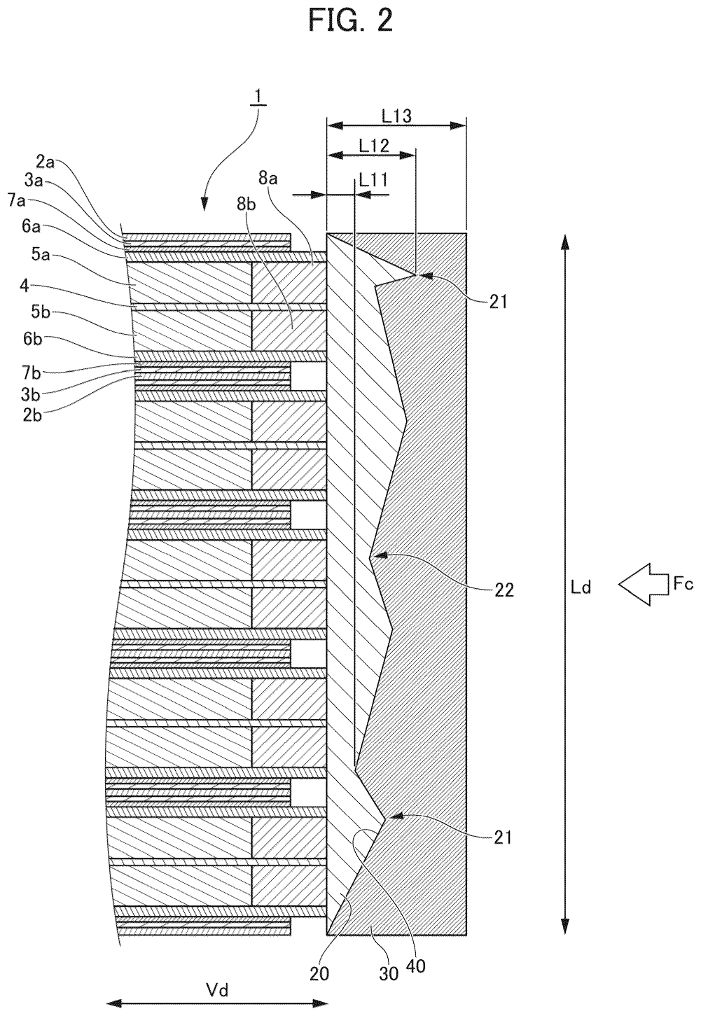

FIG. 2 is a cross-sectional view illustrating the structure of an all-solid-state battery according to the second embodiment. The configuration of the electrode stack 1 in the all-solid-state battery according to the second embodiment illustrated in FIG. 2 is generally similar to that of the electrode stack 1 in the all-solid-state battery according to the first embodiment described with reference to FIG. 1. Therefore, in FIG. 2, the corresponding parts to those in FIG. 1 are denoted by the same reference numerals, and their descriptions are incorporated by reference to the description in FIG. 1.

In FIG. 2, as in FIG. 1, Vd denotes the direction (plane direction) perpendicular to the stacking direction Ld of the electrode stack 1 constituting the all-solid-state battery. FIG. 2 also illustrates one end side (the right end side in the cross-sectional view) of the electrode stack 1 in the all-solid-state battery. The configuration of the other end side (the left end in the cross-sectional view) of the electrode stack 1 is plane-symmetrical with respect to the configuration on this one end side (see FIG. 3 as appropriate). During the module assembly process of the all-solid-state battery, the compressive input Fc acts in the Vd direction, as indicated by the thick white arrow.

In the all-solid-state battery according to the second embodiment, the insulating layer 20 composed of insulating material and the heat transfer layer 30 composed of heat-conducting material are provided in this order in the Vd direction perpendicular to the Ld direction, at the end of the positive electrode current collector 4, where the insulating materials 8a and 8b are provided. The insulating layer 20 and the heat transfer layer 30 are in contact at the interface 40. Publicly known insulating pastes can be applied as the insulating layer 20. Insulating materials such as paste-like silicon mixed with metal powder can be applied as the heat transfer layer 30.

As illustrated in FIG. 2, the insulating layer 20 and the heat transfer layer 30, which are in contact at the interface 40, extend in the Ld direction with a length equal to the thickness of the electrode stack 1 at the ends of the electrode stack 1 in the Vd direction. The interface 40 includes a concavo-convex shape portion. The concavo-convex shape portion includes the convex portions 21 protruding in the Vd direction, and the concave portions 22 that are adjacent to the convex portions 21 and relatively recessed. However, in the second embodiment illustrated in FIG. 2, the convex portions 21 and the concave portions 22 do not necessarily form a concavo-convex pattern that follows a regular arrangement as in the convex portions 21 and the concave portions 22 of the first embodiment illustrated in FIG. 1, but instead form a randomly uneven surface.

In the all-solid-state battery according to the second embodiment illustrated in FIG. 2, the minimum value L11 of the thickness of the insulating layer 20 is 0.05 mm. As a result, sufficient insulation is ensured between the positive electrode and the negative electrode without obstructing heat transfer from the electrode stack 1 to the heat transfer layer 30 via the insulating layer 20. The minimum value L11 of the thickness of the insulating layer 20 is more preferably at least 0.1 mm.

The maximum value L12 of the thickness of the insulating layer 20 is at least 1.1 times the minimum value L13, and is no greater than the maximum value L13 of the thickness of the heat transfer layer, in which the maximum value L13 of the thickness of the heat transfer layer is no greater than 20 mm. This value of the thickness of the heat transfer layer represents a practical maximum value from the perspective of energy density. In this case, the maximum value L13 of the thickness of the heat transfer layer is more preferably no greater than 2 mm. In FIG. 2, for convenience and to avoid line overlap, L11 is depicted within the range of L13; however, the thickness of the heat transfer layer 30 is separate from the thickness of the insulating layer 20.

The primary difference between the all-solid-state battery according to the second embodiment illustrated in FIG. 2 and the all-solid-state battery according to the first embodiment illustrated in FIG. 1 is as follows. Specifically, while the plurality of concavo-convex shape parts in the all-solid-state battery according to the first embodiment form a concavo-convex pattern that follows a specific regular arrangement, the concavo-convex shape parts in the all-solid-state battery according to the second embodiment form a random concavo-convex pattern. According to simulations, even in cases where the plurality of concavo-convex shape parts at the interface 40 between the insulating layer 20 and the heat transfer layer 30 are formed into a random concavo-convex pattern, heat is also effectively dissipated from the electrode stack 1.

### (Configuration of All-Solid-State Battery)

Hereinafter, the configurations of the all-solid-state battery of the present disclosure will be described.

### (Positive Electrode Current Collector)

The positive electrode current collector used in the all-solid-state battery of the present disclosure is arranged in contact with the positive electrode layer, and functions to collect current from the positive electrode layer. The material for the positive electrode current collector is not particularly limited, as long as the material can collect current from the positive electrode layer. Examples of materials for the positive electrode current collector include aluminum, aluminum alloys, stainless steel, nickel, iron, and titanium. Among these, at least one selected from the group consisting of aluminum, aluminum alloys, and stainless steel is preferred.

The shape of the positive electrode current collector is not particularly limited, and may include, for example, foil or plate forms. The thickness of the positive electrode current collector is not particularly limited, and may be the same as those used in positive electrodes of typical all-solid-state batteries. The thickness of the positive electrode current collector may range, for example, between 0.5 μm and 0.5 mm inclusive.

### (Positive Electrode Layer)

The positive electrode layer is a layer containing at least a positive electrode active material. The positive electrode active material contained in the positive electrode layer is not particularly limited, as long as the material is the one typically used in positive electrode layers of all-solid-state batteries. Examples of positive electrode active materials for lithium-ion batteries include lithium-containing layered active materials, spinel-type active materials, and olivine-type active materials. Specific examples of positive electrode active materials include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), Li₁₊ₓMn_{2-x-y}M_{y}O₄ (x+y=2, M=at least one selected from Al, Mg, Co, Fe, Ni, or Zn), lithium titanium oxide (oxide containing Li and Ti), and lithium metal phosphate (LiMPO₄, M=at least one selected from Fe, Mn, Co, or Ni).

The content of the positive electrode active material in the positive electrode layer may range between 50% by mass and 99% by mass inclusive, for example. The positive electrode active material may have a surface coated with an oxide layer such as a lithium niobate layer, a lithium titanate layer, or a lithium phosphate layer.

The positive electrode layer may optionally include a solid electrolyte, described later, to improve lithium-ion conductivity. The positive electrode layer may also optionally contain binders or conductive additives. These materials may be those typically used for all-solid-state batteries.

The thickness of the positive electrode layer is not particularly limited, and can be appropriately set based on the desired battery performance. For example, the thickness of the positive electrode layer may range between 1 μm and 1 mm inclusive.

In a case where the all-solid-state battery of the present disclosure includes an intermediate layer described later, the area of the positive electrode layer is preferably equivalent to the area of the intermediate layer on the stacking surface. As a result, the durability performance of the all-solid-state battery can be improved. The area of the positive electrode layer in the all-solid-state battery of the present disclosure may be up to 100%, 90% to 100%, or 80% to 90% of the area of the intermediate layer.

The method of manufacturing the positive electrode layer is not particularly limited, and the positive electrode layer may be manufactured with publicly known methods. For example, the positive electrode layer can be manufactured by mixing the materials constituting the positive electrode layer with a solvent to form a slurry, applying the slurry to the positive electrode current collector described above, followed by drying.

### (Solid Electrolyte Layer)

The solid electrolyte layer is a layer containing a solid electrolyte. The solid electrolyte layer is arranged in contact with the positive electrode layer and the insulating material.

The material for the solid electrolyte is not particularly limited, as long as the material has lithium-ion conductivity and insulation properties. Materials typically used in all-solid-state lithium-ion batteries can be used as the solid electrolyte. Examples include inorganic solid electrolytes such as sulfide solid electrolytes, oxide solid electrolytes, halide solid electrolytes, and lithium-containing salts; polymer-based solid electrolytes such as polyethylene oxide; and gel-based solid electrolytes containing lithium salts or lithium-ion conductive ionic liquids. Among these, sulfide solid electrolytes are preferred for the high lithium-ion conductivity and favorable characteristics for press forming and interface bonding.

The form of the solid electrolyte material is not particularly limited, and may be, for example, particulate. In the solid electrolyte layer in the all-solid-state battery of the present disclosure, the content of the solid electrolyte is not particularly limited. For example, the content of the solid electrolyte may range between 50% by mass and 99% by mass inclusive.

The solid electrolyte layer may optionally contain a binder. The solid electrolyte layer may also optionally include an adhesive to impart mechanical strength or flexibility. These materials may be those typically used in all-solid-state batteries.

The solid electrolyte layer may be arranged such that the end substantially aligns with the end of the insulating material in the direction perpendicular to the stacking direction of the electrode stack in the all-solid-state battery of the present disclosure.

In the electrode stack with such a shape, the solid electrolyte layer does not protrude from the end face of the electrode stack, thereby allowing for reducing the risk of cracks forming in the solid electrolyte layer, in a case where pressure, such as from roll pressing, is applied during the manufacturing process of the electrode stack.

The method of manufacturing the solid electrolyte layer is not particularly limited, and the solid electrolyte layer may be manufactured with publicly known methods. For example, the solid electrolyte layer can be manufactured by mixing the materials constituting the solid electrolyte layer with a solvent to form a slurry, applying the slurry to a substrate, followed by drying.

### (Negative Electrode Current Collector)

The negative electrode current collector used in the all-solid-state battery of the present disclosure is arranged in contact with the negative electrode layer, and functions to collect current from the negative electrode layer. The material for the negative electrode current collector is not particularly limited, as long as the material can collect current from the negative electrode layer. However, the material preferably has high electrical conductivity.

Examples of materials with high electrical conductivity include metals containing at least one metallic element selected from the group consisting of silver, palladium, gold, platinum, aluminum, copper, and nickel; alloys such as stainless steel; or non-metals such as carbon (C).

Among these materials with high electrical conductivity, at least one material selected from the group consisting of copper, SUS (stainless steel), and nickel is preferably used considering both electrical conductivity and manufacturing cost. In particular, stainless steel is less reactive with the negative electrode active material, the positive electrode active material, and the solid electrolyte. Therefore, using stainless steel as the material for the negative electrode current collector can reduce the internal resistance of the all-solid-state battery.

The shape of the negative electrode current collector is not particularly limited, and may include forms such as foil, plate, mesh, nonwoven fabric, or foam. The negative electrode current collector may have a surface coated with a carbon layer, or have a surface roughened, in order to enhance adhesion with the negative electrode layer.

The thickness of the negative electrode current collector is not particularly limited, and may be the same as those used in negative electrodes of typical all-solid-state batteries. The thickness of the negative electrode current collector may range, for example, between 0.5 μm and 0.5 mm inclusive.

### (Negative Electrode Layer)

The negative electrode layer is a layer containing a negative electrode active material that exchanges lithium ions and electrons. The negative electrode active material contained in the negative electrode layer is not particularly limited, as long as the material is the one typically used in negative electrode layers of all-solid-state batteries. However, a material with high electronic conductivity is preferably used to enable reversible lithium-ion release/storage and to facilitate electron transport. Examples of such negative electrode active materials include silicon-based active materials such as silicon and silicon alloys; carbon-based active materials such as graphite and hard carbon; oxide-based active materials such as lithium titanium oxide; lithium-based active materials such as lithium metal and lithium alloys. The negative electrode active material may be used alone or in combination of two or more types.

In the all-solid-state battery of the present disclosure, the negative electrode layer may consist of lithium metal or a lithium metal alloy, alone or in combination. A negative electrode layer including lithium metal or lithium metal alloy, alone or in combination, has high electrical capacitance per unit weight, thus can realize a high-capacity all-solid-state battery.

The content of the negative electrode active material in the negative electrode layer may range, for example, between 30% by mass and 100% by mass inclusive.

The negative electrode layer may optionally contain the solid electrolyte described above to improve lithium-ion conductivity. The negative electrode layer may also optionally contain binders or conductive additives. These materials may be those typically used for all-solid-state batteries.

The thickness of the negative electrode layer is not particularly limited, and can be appropriately set based on the desired battery performance. The thickness of the negative electrode layer may range, for example, between 0.5 μm and 0.5 mm inclusive.

The method of manufacturing the negative electrode layer is not particularly limited, and the negative electrode layer may be manufactured with publicly known methods. For example, the negative electrode layer can be manufactured by mixing the materials constituting the negative electrode layer with a solvent to form a slurry, applying the slurry to the negative electrode current collector mentioned above, followed by drying.

### (Intermediate Layer)

In a case where the all-solid-state battery of the present disclosure includes an intermediate layer, the intermediate layer is provided between the solid electrolyte and the negative electrode layer. In a case where the negative electrode layer of the all-solid-state battery of the present disclosure consists of lithium metal or a lithium metal alloy, alone or in combination, the intermediate layer provided between the solid electrolyte layer and the negative electrode layer can suppress uneven dendritic deposition at the interface between the solid electrolyte layer and the negative electrode layer and improve interfacial adhesion.

The intermediate layer is a layer having both electronic conductivity and ionic conductivity. The intermediate layer has ionic conductivity, thus can allow lithium ions to pass through. Therefore, during repeated charge and discharge cycles of the all-solid-state battery, lithium ions (Li+) migrating from the solid electrolyte layer to the negative electrode layer pass through the intermediate layer. The presence of the intermediate layer allows uniform deposition of lithium metal between the intermediate layer and the negative electrode layer. In a case where the intermediate layer has flexibility to follow the changes in volume of each layer during charge and discharge cycles, interfacial adhesion can be maintained even after repeated charge and discharge cycles of the all-solid-state battery, thereby allowing for improving the durability of the all-solid-state battery.

The intermediate layer may be arranged such that the end substantially aligns with the end of the negative electrode layer, or may be arranged inside the end of the negative electrode layer, in the direction perpendicular to the stacking direction of the electrode stack in the all-solid-state battery of the present disclosure. As a result, the effects by providing the intermediate layer as described above can be sufficiently achieved.

The material constituting the intermediate layer is not particularly limited. For example, the intermediate layer may contain amorphous carbon, metal nanoparticles, and binders as binding agents.

Amorphous carbon, unlike graphite and similar materials, does not react with lithium metal to form an alloy. This characteristic suppresses dendritic formation, thereby allowing for improving the cycle characteristics of the all-solid-state battery.

Examples of amorphous carbon include carbon blacks such as acetylene black, furnace black, and Ketjen black, as well as coke and activated carbon. Amorphous carbon may also include graphitizable carbon (soft carbon), non-graphitize carbon (hard carbon), CNT (carbon nanotubes), fullerenes, and graphene.

Metal nanoparticles included in the intermediate layer can enhance the electronic conductivity of the intermediate layer, allowing for more uniform deposition of lithium metal. Examples of metal nanoparticles are not particularly limited, and include tin, silicon, zinc, magnesium, gold, platinum, palladium, silver, aluminum, bismuth, and antimony nanoparticles.

The binder included in the intermediate layer maintains the structure of the intermediate layer, and improves adhesion between the particles constituting the intermediate layer, and between the intermediate layer and the solid electrolyte layer. The binder is not particularly limited, and may be a material typically used in all-solid-state batteries.

### (Insulating Material)

The insulating material is provided on the surface of the positive electrode current collector on the side of the positive electrode layer, adjacent to the end of the positive electrode layer. The insulating material is arranged at the ends of the positive electrode layer, thereby allowing for preventing short-circuits during battery operation when tab wires extending from the negative electrode current collectors of individual cell structures are bent, avoiding contact between the tab wires and the ends of the positive electrode. This configuration can also suppress short-circuits caused by cracks generated during repeated charge and discharge cycles. Furthermore, cracks can be prevented from forming at the ends of the positive electrode mixture layer due to roll-over during roll pressing of the positive electrode.

The shape of the insulating material is not particularly limited as long as the insulating material is provided at the ends of the positive electrode layer. The size of the insulating material is also not particularly limited, as long as the insulating material has a thickness equal to or less than the thickness of the positive electrode layer in the stacking direction of the electrode stack, and is arranged at the ends of the positive electrode layer in the direction perpendicular to the stacking direction of the electrode stack, in contact with part or all of the ends of the positive electrode layer.

The material for the insulating material is not particularly limited, and may be any insulator other than semiconductors and conductors, as long as the material exhibits insulating properties. The material for the insulating material can be appropriately selected based on the properties desired in addition to insulating properties. As the materials for the insulating materials, materials without electronic conductivity are used; however, materials with ionic conductivity are usable, and solid electrolytes are also usable.

The method of manufacturing the insulating material is not particularly limited. For example, the insulating material can be manufactured by applying a slurry containing an insulating material onto the positive electrode current collector, on which the positive electrode layer has been formed, followed by drying.

### (Method of Manufacturing All-Solid-State Battery)

The method of manufacturing the all-solid-state battery of the present disclosure is not particularly limited, and may employ publicly known methods. For example, the negative electrode current collector, the negative electrode layer, the intermediate layer, the solid electrolyte layer, the positive electrode layer, and the positive electrode current collector are stacked in this order, and the insulating material is formed on the positive electrode current collector at both ends of the positive electrode layer, thereby producing an electrode body. Subsequently, a plurality of electrode bodies are stacked, optionally pressed for integration, thereby forming an electrode stack. Finally, the insulating layer and the heat transfer layer are provided in this order at the ends of the electrode stack, viewed in the direction perpendicular to the stacking direction, thereby allowing for producing the all-solid-state battery of the present disclosure.

The preferred embodiments of the present invention have been described above; however, the present invention is not limited to the embodiments described above, and modifications or improvements within the scope of achieving the object of the present invention are included in the present invention.

### EXPLANATION OF REFERENCE NUMERALS

1: electrode stack
2a, 2b: negative electrode current collector
3a, 3b: lithium metal layer (negative electrode layer)
4: positive electrode current collector
5a, 5b: positive electrode active material layer (positive electrode layer)
6a, 6b: solid electrolyte layer
7a, 7b: intermediate layer
8a, 8b: insulating material
9: resin coating
20: insulating layer
30: heat transfer layer
40: interface
Ld: stacking direction of electrode stack
Vd: direction (plane direction) perpendicular to stacking direction of electrode stack

What is claimed is:

1. An all-solid-state battery, comprising:
an electrode stack including a plurality of electrode bodies stacked, each of the electrode bodies including a positive electrode current collector, a positive electrode layer, a solid electrolyte layer, a negative electrode layer, and a negative electrode current collector stacked in this order, and a positive electrode insulating layer at an end of the positive electrode current collector, protruding in a plane direction of the positive electrode current collector, wherein
an insulating layer and a heat transfer layer are provided in this order at an end of the electrode stack in a direction perpendicular to a stacking direction, and
an interface between the insulating layer and the heat transfer layer includes a concavo-convex shape portion.

2. The all-solid-state battery according to claim 1, wherein a minimum value of a thickness of the insulating layer is 0.05 mm.

3. The all-solid-state battery according to claim 1, wherein a maximum value of the thickness of the insulating layer is at least 1.1 times the minimum value of the thickness, and is no greater than a maximum value of a thickness of the heat transfer layer, and the maximum value of the thickness of the heat transfer layer is no greater than 20 mm.

4. The all-solid-state battery according to claim 1, wherein the concavo-convex shape portion includes a plurality of concavo-convex shape parts.

5. The all-solid-state battery according to claim 4, wherein the plurality of concavo-convex shape parts form a concavo-convex pattern that follows a specific regular arrangement.

6. The all-solid-state battery according to claim 5, wherein a gap between adjacent convex portions in the plurality of concavo-convex shape parts on a side of the insulating layer is at least 0.05 mm.

7. The all-solid-state battery according to claim 4, wherein the plurality of concavo-convex shape parts form a random concavo-convex pattern.
